(19) United States
(12) Patent Application Publication
(10) Pub. No.: US 2004/0262894 A1
(43) Pub. Date: Dec. 30, 2004

(54) Hood airbag for pedestrian protection

(76) Inventor: Peter C. Kempf, Dexter, MI (US)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/602,870

(22) Filed: Jun. 25, 2003

(51) Int. Cl. B60R 21/22; B60R 21/34

(52) U.S. Cl. 280/730.1; 180/274

(57) ABSTRACT

An airbag module has an airbag inflator and a vehicle hood airbag. The vehicle hood airbag is inflated by the airbag inflator and oriented to deploy at an acute angle over a vehicle hood. Following deployment, the vehicle airbag has an airbag length and an airbag width. The airbag length is sized to extend only substantially along the vehicle hood length while the airbag width is sized to extend substantially across a vehicle hood width.

### FIELD OF THE INVENTION

The present invention relates to an external airbag module to protect a pedestrian.

### BACKGROUND OF THE INVENTION

Airbags are commonly employed to protect a vehicle occupant from injury in a crash. Recently, vehicle manufacturers have considered using airbags to protect individuals outside of the vehicle from injury. Current pedestrian airbag systems focus on preventing injury to a pedestrian who may hit the windshield of the vehicle. Accordingly, these airbags deploy from the rear of the vehicle hood and over the vehicle windshield. In this way, the pedestrian is cushioned from injury resulting from impact with the vehicle windshield.

While the hood of the vehicle does not pose as significant of a threat to a pedestrian as the vehicle windshield, it has been discovered that there are a significant number of hard points under the hood that a pedestrian may encounter in a front end collision with a vehicle. One known airbag design attempts to cushion these hard points by deploying an external airbag from a vehicle bumper over the vehicle hood. However, the design lacks features that allow the external airbag to deploy quickly onto the vehicle hood.

Exterior airbag systems are expensive. In an accident involving a pedestrian, the vehicle may receive very insignificant damage. Nevertheless, the airbag will deploy to protect the pedestrian. In light of the minimal damage to the body of the vehicle, it would be desirable to offer an airbag system that may be easily reinstalled after deployment.

There is a need for an inexpensive exterior airbag system that protects a pedestrian from injury caused by the hard points of the vehicle hood and overcomes the deficiencies of existing external airbag designs.

### SUMMARY OF THE INVENTION

The present invention comprises an external airbag and an airbag inflator for a vehicle hood. Unlike existing external airbag systems, the inventive airbag module is oriented to deploy at an acute angle to the vehicle hood so that the airbag may deploy quickly over a vehicle hood. The airbag is further sized to cover the entire vehicle hood. In addition, the inventive airbag has elements that allow the airbag to be repacked and reused, thereby reducing the overall cost of the system over the life of the vehicle.

In addition, the vehicle hood airbag may deploy from a front area of the vehicle rather than near the windshield as some existing airbag systems do. The airbag may deploy from the front area of the vehicle hood to the rear area of the vehicle hood and cover entirely the vehicle hood when deployed. In this way, the pedestrian is protected from injury caused by any hard points that may exist under the vehicle hood.

In light of the size of the airbag, it is particularly desirable to avoid replacing the airbag. Accordingly, the inventive airbag uses an airbag inflator that will not damage the airbag during deployment. Rather than using a combustion gas generator inflator, the inventive airbag preferably uses a pressurized gas inflator, such as a CO₂ cartridge. Gas from this cartridge is cold and will not burn the vehicle hood airbag. Thus, after deployment, the spent inflation gas cartridge may be replaced and the existing airbag may be repacked.

The airbag and the airbag inflator may be stored in a storage compartment housing located at the front of the vehicle. The storage compartment housing may have a door that opens during airbag deployment. Following deployment, the airbag may be repacked, the airbag inflator may be replaced, and the door to the storage compartment closed. The door to the storage compartment may be part of the exterior of the vehicle.

### BRIEF DESCRIPTION OF THE DRAWINGS

The various features and advantages of this invention will become apparent to those skilled in the art from the following detailed description of the currently preferred embodiment.

FIG. 1 is a side view of a vehicle equipped with the inventive airbag module in an undeployed state.

FIG. 2 is a side view of the vehicle of FIG. 1 as the airbag deploys.

FIG. 3 illustrates the vehicle of FIGS. 1 and 2 with the airbag in a fully deployed state.

FIG. 4 is a side view of the vehicle of FIG. 3.

FIG. 5 illustrates the replacement of the airbag inflator.

FIG. 6 illustrates placing the airbag back into into the vehicle storage compartment.

### DETAILED DESCRIPTION OF THE INVENTION

As used herein and in the claims terms describing a location such as “forward”, “rear”, “front”, “back”, “up” and “down” are understood to relate to such locations relative to a motor vehicle.

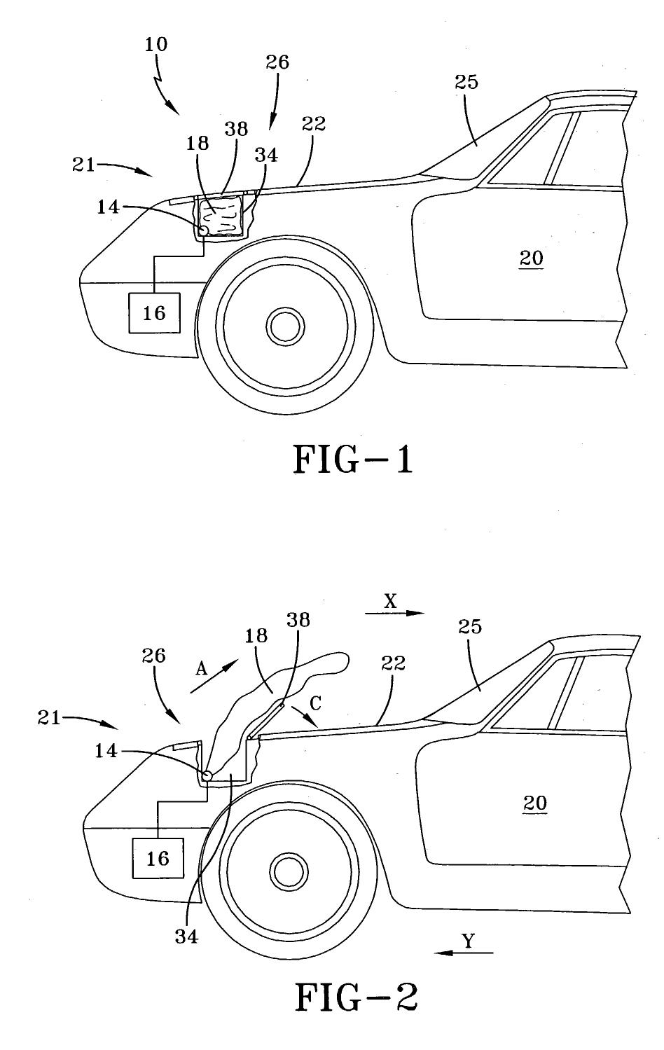

FIG. 1 is a side view of a vehicle equipped with the inventive airbag module 10. As shown, airbag module 10 comprises airbag inflator 14 and vehicle hood airbag 18. The airbag inflator 14 is controlled by an impact detection system 16. When the impact detection system 16 detects an impact with an object, such as a pedestrian, the airbag inflator 14 is instructed to release a pressurized inflation gas. Preferably, the airbag inflator 14 is a pressurized cartridge containing inflation gas that releases a cold CO₂ gas to inflate the airbag 18 so as to avoid damaging the airbag 14.

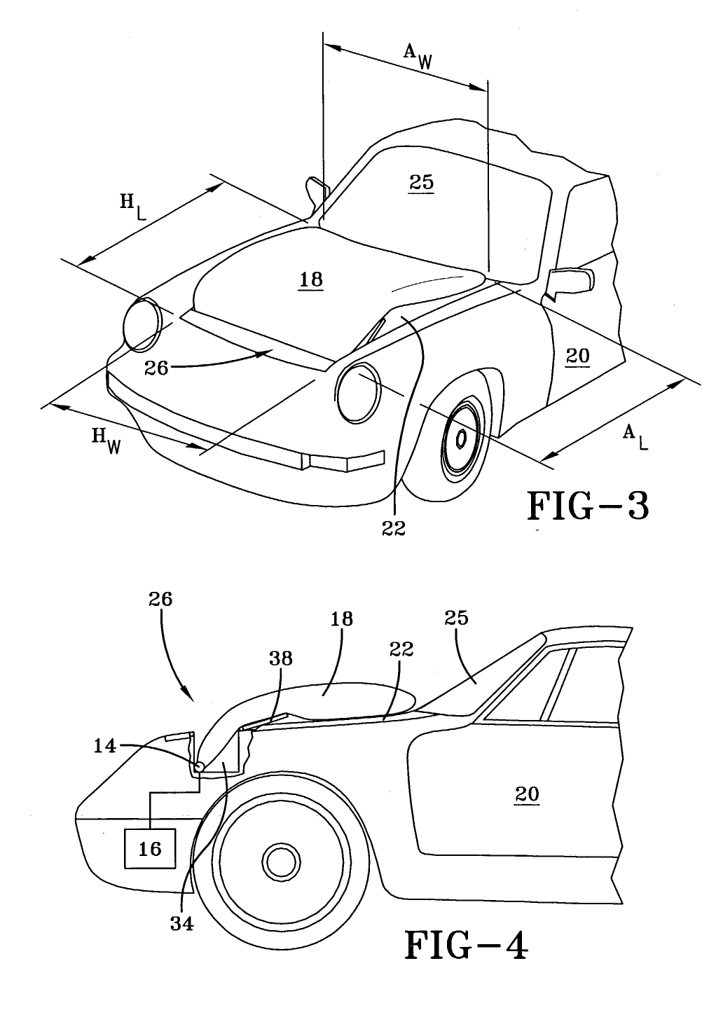

As shown in FIG. 2, the airbag module 10 is located at the front of vehicle 20 ahead of a vehicle hood 22. At the front 21 of vehicle 20, the airbag 18 is positioned to deploy over the vehicle hood 22 at an acute angle relative to the vehicle hood 22 along the direction of arrow A in contrast to deployment at a generally perpendicular angle like existing airbags for a vehicle hood. The deployment of the airbag 18 at such an angle greatly reduces the amount of time for the airbag 18 to reach its resting position over vehicle hood 22 as shown in FIGS. 3 and 4.

When the impact detection system 16 instructs the airbag inflator 14 to the inflate airbag 18, the airbag 18 is projected over vehicle hood 22 in the direction of arrow A and starts to pivot in the direction of arrow X. The impact detection system may be of any suitable design including for example a magnetostrictive sensor or pressure sensor. Because the airbag module 10 is located in a forward area 26 of the vehicle hood 22, movement of the vehicle 20 in the direction of arrow Y as well as gravity will assist pivoting of the airbag 18 in the direction of arrow X as the airbag 18 deploys. Due to the velocity of the vehicle 20 in the direction of arrow Y, wind traveling over the vehicle 20 will also tend to move the airbag 18 in the direction of arrow X over the vehicle hood 22.

FIG. 3 illustrates the airbag 18 in a fully deployed position. As shown, when fully deployed, the airbag 18 has an airbag width A_{W} and an airbag length A_{L}. The airbag width A_{W} is about the width of vehicle hood 22 H_{W}, while the airbag length A_{L} is about the same as the length of the vehicle hood 22, H_{L}. In this way, the airbag 18 is large enough to cover a substantial portion of the vehicle hood 22 without impairing the vision of the vehicle operator. Preferably, the airbag 18 covers the vehicle hood 22 completely so that many of the hard points underneath the vehicle hood 22 are cushioned.

FIG. 4 is a side view of a vehicle with a fully deployed airbag 18 on the vehicle hood 22. The airbag 18 extends across the vehicle hood 22 and may terminate at a vehicle windshield 25 so as to permit the vehicle driver to see without the obstruction of the airbag 18.

The airbag 18 is stored in a vehicle storage compartment 34, which also houses the airbag inflator 14. When stored as shown in FIG. 1, the vehicle storage compartment 34 has a hinged door 38. As shown in FIG. 1, the door 38 forms part of the outer skin of the vehicle 20 and, preferably, shares the same paint color as other exterior portions of the vehicle 20. When the airbag 18 deploys, as shown in FIG. 2, the door 38 pivots in the direction of arrow C to an open position.

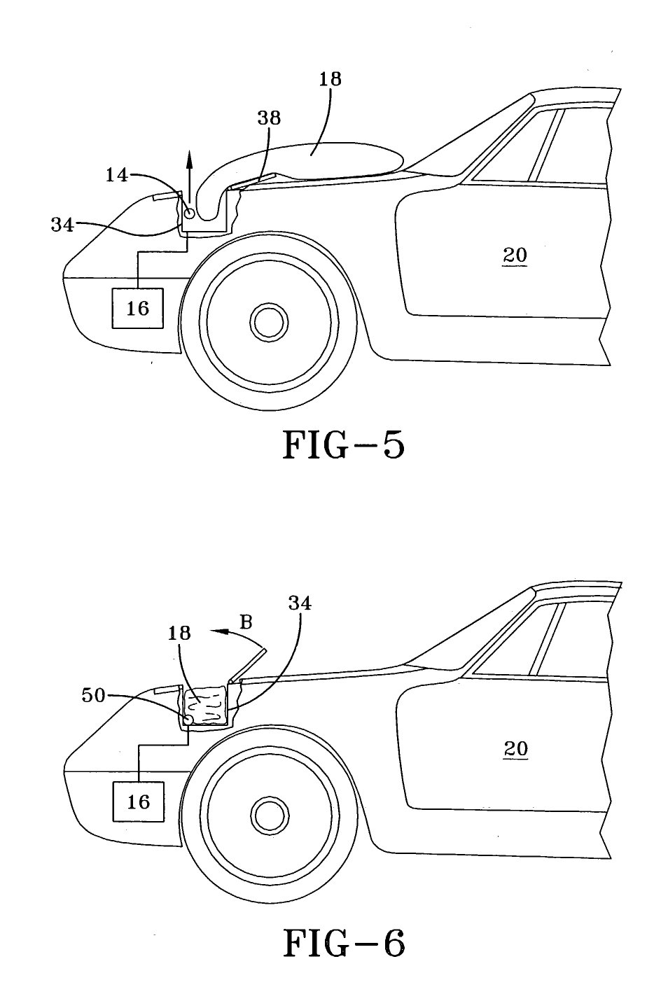

FIGS. 5 and 6 illustrate how the airbag module 10 may be serviced for reuse without great additional expense. As already mentioned, the airbag inflator 14 releases a pressurized cold inflation gas into the airbag 18 during deployment. Thus, in contrast to hot inflation gas combustion airbag inflators, the airbag inflator 14 will not burn or damage the airbag 18 during deployment. The airbag 18 may then be repacked and returned to the vehicle storage container 34 as shown in FIG. 6. In addition, the airbag inflator 14 may be replaced in a cartridge-like fashion with another airbag inflator 50. The door 38 may be closed on its hinge along the direction of arrow B. In this way, the inventive airbag module 10 may be reused without significant additional cost.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. An airbag module for protecting a pedestrian comprising:
an airbag inflator;
a vehicle hood airbag in communication with said airbag inflator;
wherein said vehicle hood airbag is oriented to deploy at an acute angle to a vehicle hood; and
wherein said vehicle hood airbag has an airbag length and an airbag width, said airbag length sized to extend only substantially along a vehicle hood length and said airbag width sized to extend substantially across a vehicle hood width.

2. The airbag module of claim 1 wherein said vehicle hood airbag is deployable from a location in forward of the vehicle hood.

3. The airbag module of claim 2 wherein said vehicle hood airbag is deployable to extend from the location in forward of the vehicle hood to a rear area of the vehicle hood.

4. The airbag module of claim 3 wherein said vehicle hood airbag covers substantially the entire vehicle hood when deployed.

5. The airbag module of claim 1 wherein said airbag inflator stores a pressurized inflation gas.

6. The airbag module of claim 1 including a vehicle storage compartment housing said airbag inflator and said vehicle hood airbag.

7. The airbag module of claim 6 wherein said vehicle storage compartment comprises a door hinged to said vehicle storage compartment, said door having a first position when said vehicle hood airbag is deployed and a second position when said vehicle hood airbag is not deployed.

8. The airbag module of claim 7 wherein said door comprises an outer skin of a vehicle.

9. The airbag module of claim 1 wherein said airbag length is about the same as said vehicle hood length.

10. A vehicle hood airbag module, comprising:
an airbag inflator storing a pressurized inflation gas;
a vehicle hood airbag in communication with said airbag inflator;
a vehicle storage compartment housing said airbag inflator and said airbag;
a door hinged to said vehicle hood storage compartment, said door having a first position when said airbag is deployed and a second position when said airbag is not deployed wherein said door comprises an outer skin of a front area of a vehicle in said second position; and
said airbag has an airbag length and an airbag width, said airbag length sized to extend only substantially along a vehicle hood length and said airbag width sized to extend substantially across a vehicle hood width.

11. The airbag module of claim 10 wherein said vehicle hood airbag is deployable from a front area of a vehicle hood at an acute angle to the vehicle hood.

12. The airbag module of claim 11 wherein said vehicle hood airbag is deployable to extend from the front area of a vehicle hood to a rear area of the vehicle hood.

13. The airbag module of claim 12 wherein said vehicle hood airbag covers the entire vehicle hood when deployed.

14. The airbag module of claim 10 wherein said airbag length is substantially the same as said vehicle hood length.

15. A method of airbag maintenance, comprising the steps of:
compacting a deployed vehicle hood airbag;
removing a discharged inflator cartridge; and
replacing the discharged inflator cartridge with a pressurized inflator cartridge.
